(19) United States
(12) Patent Application Publication
(10) Pub. No.: US 2024/0337779 A1
(43) Pub. Date: Oct. 10, 2024

(54) OPTICAL DEVICE

(71) Applicant: TONG HSING ELECTRONIC INDUSTRIES, LTD., Taipei City (TW)

(72) Inventors: CHIA-SHUAI CHANG, Hsin-Chu County (TW); CHIEN-HUNG LIN, Taipei City (TW); WEN-FU YU, Taipei City (TW); WEI-LI WANG, Taipei City (TW); BAE-YINN HWANG, Taipei City (TW); JYUN-HUEI JIANG, Taipei City (TW)

(21) Appl. No.: 18/515,167

(22) Filed: Nov. 20, 2023

Related U.S. Application Data
(60) Provisional application No. 63/458,158, filed on Apr. 9, 2023.

(30) Foreign Application Priority Data
Sep. 7, 2023 (TW) 112134001

(51) Int. Cl. G02B 5/02

(52) U.S. Cl. CPC G02B 5/0215

(57) ABSTRACT

An optical device includes an electronic component, a light-permeable layer, and a ring-shaped adhesive layer that is sandwiched between the electronic component and the light-permeable layer. The ring-shaped adhesive layer surrounds an optical region of the electronic component and includes a plurality of light-weakening slots that are formed on an inner side surface thereof. The light-weakening slots are in a ring-shaped arrangement and surround the optical region. Each of the light-weakening slots has a slot opening having a slot width and a slot bottom spaced apart from the slot opening by a slot depth. A width of each of the light-weakening slots gradually decreases along a direction from the slot opening to the slot bottom, and a ratio of the slot width to the slot depth is within a range from 1:0.86 to 1:11.4, such that each of the light-weakening slots is configured to weaken light irradiated thereon.

### CROSS-REFERENCE TO RELATED PATENT APPLICATION

This application claims the benefit of priority to Taiwan Patent Application No. 112134001, filed on Sep. 7, 2023. The entire content of the above identified application is incorporated herein by reference.

This application claims the benefit of priority to the U.S. Provisional Patent Application Ser. No. 63/458,158, filed on Apr. 9, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an optical device, and more particularly to an optical device having a plurality of light-weakening slots.

### BACKGROUND OF THE DISCLOSURE

A conventional optical device includes a glass board, an optical component, and an adhesive layer that is sandwiched between the glass board and the optical component. However, in the conventional optical device, the adhesive layer usually generates an abnormal refraction or reflection phenomenon due to light being irradiated thereon.

### SUMMARY OF THE DISCLOSURE

In response to the above-referenced technical inadequacies, the present disclosure provides an optical device for effectively improving on the issues associated with conventional optical devices.

In order to solve the above-mentioned problems, one of the technical aspects adopted by the present disclosure is to provide an optical device, which includes an electronic component, a ring-shaped adhesive layer, and a light-permeable layer. The electronic component has a top surface. The top surface of the electronic component has an optical region and a carrying region that surrounds the optical region. The ring-shaped adhesive layer is disposed on the carrying region of the electronic component and surrounds the optical region. The ring-shaped adhesive layer includes a plurality of light-weakening slots that are formed on an inner side surface thereof and that face toward the optical region. The ring-shaped adhesive layer includes a plurality of strips in a ring-shaped arrangement, and each of the strips includes an inner layout segment and two outer layout segments that are respectively connected to two opposite ends of the inner layout segment. The light-weakening slots are recessed in the inner layout segments of two of the strips facing toward each other. The light-permeable layer is disposed on the ring-shaped adhesive layer. The light-permeable layer, the inner side surface of the ring-shaped adhesive layer, and the top surface of the electronic component jointly define an enclosed space. Each of the light-weakening slots has a slot opening and a slot bottom that is spaced apart from the slot opening by a slot depth. Moreover, the slot opening each of the light-weakening slots has a slot width, a width of each of the light-weakening slots gradually decreases along a direction from the slot opening to the slot bottom, and a ratio of the slot width to the slot depth is within a range from 1:0.86 to 1:11.4, such that each of the light-weakening slots is configured to weaken light that irradiates thereon by entering into the enclosed space.

In order to solve the above-mentioned problems, another one of the technical aspects adopted by the present disclosure is to provide an optical device, which includes an electronic component, a ring-shaped adhesive layer, and a light-permeable layer. The electronic component has a top surface. The top surface of the electronic component has an optical region and a carrying region that surrounds the optical region. The ring-shaped adhesive layer is disposed on the carrying region of the electronic component and surrounds the optical region. The ring-shaped adhesive layer includes a plurality of light-weakening slots that are formed on an inner side surface thereof and that face toward the optical region. The light-weakening slots are in a ring-shaped arrangement and surround the optical region at an outer side of the optical region. The light-permeable layer is disposed on the ring-shaped adhesive layer. The light-permeable layer, the inner side surface of the ring-shaped adhesive layer, and the top surface of the electronic component jointly define an enclosed space. Each of the light-weakening slots has a slot opening and a slot bottom that is spaced apart from the slot opening by a slot depth. Moreover, the slot opening of each of the light-weakening slots has a slot width, a width of each of the light-weakening slots gradually decreases along a direction from the slot opening to the slot bottom, and a ratio of the slot width to the slot depth is within a range from 1:0.86 to 1:11.4, such that each of the light-weakening slots is configured to weaken light that irradiates thereon by entering into the enclosed space.

Therefore, in the optical device provided by the present disclosure, by virtue of “the inner side surface of the ring-shaped adhesive layer having the light-weakening slots of the ratio being within a range from 1:0.86 to 1:11.4,” light irradiated on the inner side surface of the ring-shaped adhesive layer can be weakened by being dispersed into the light-weakening slots, thereby effectively preventing the ring-shaped adhesive layer from generating an abnormal refraction or reflection phenomenon due to the light being irradiated thereon.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of an optical device according to a first embodiment of the present disclosure;

FIG. 2 is a schematic cross-sectional view showing a part of FIG. 1;

FIG. 3 is a schematic top view of FIG. 1;

FIG. 4 is a schematic enlarged view of part IV of FIG. 3;

FIG. 5 is a schematic top view showing the optical device of FIG. 1 in another configuration;

FIG. 6 is a schematic enlarged view showing the optical device of FIG. 4 in another configuration;

FIG. 7 is a schematic enlarged view showing the optical device of FIG. 4 in yet another configuration;

FIG. 8 is a schematic cross-sectional view taken along line VIII-VIII of FIG. 1;

FIG. 9 is a schematic cross-sectional view showing the optical device of FIG. 8 in another configuration;

FIG. 10 is a schematic top view of the optical device according to a second embodiment of the present disclosure;

FIG. 11 is a schematic enlarged view of part XI of FIG. 10;

FIG. 12 is a schematic top view of the optical device in another configuration according to the second embodiment of the present disclosure;

FIG. 13 is a schematic top view of the optical device according to a third embodiment of the present disclosure;

FIG. 14 is a schematic top view of the optical device in another configuration according to the third embodiment of the present disclosure; and

FIG. 15 is a schematic top view of the optical device in yet another configuration according to the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

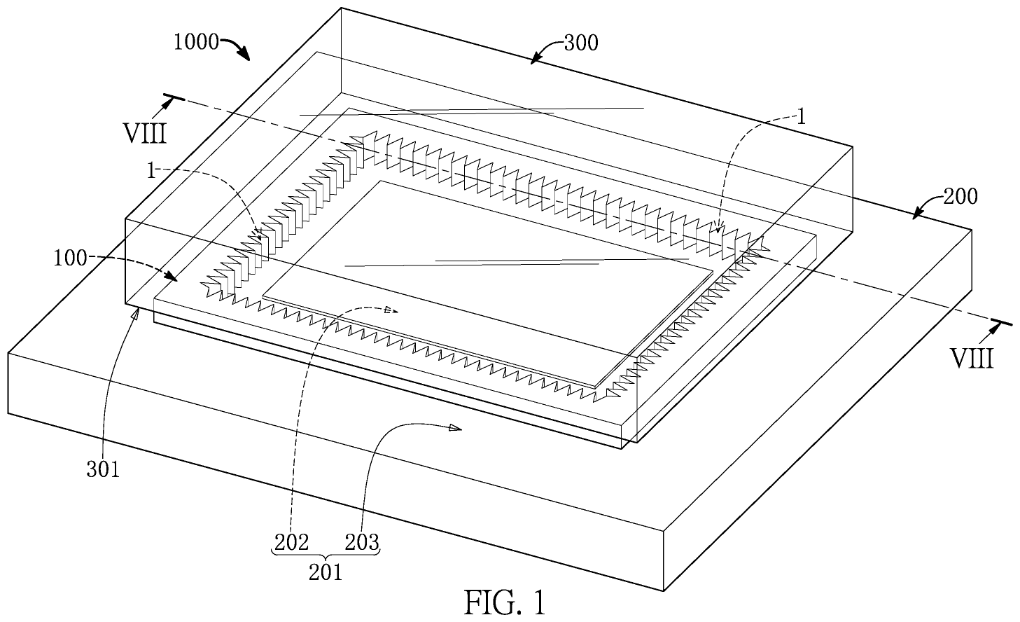

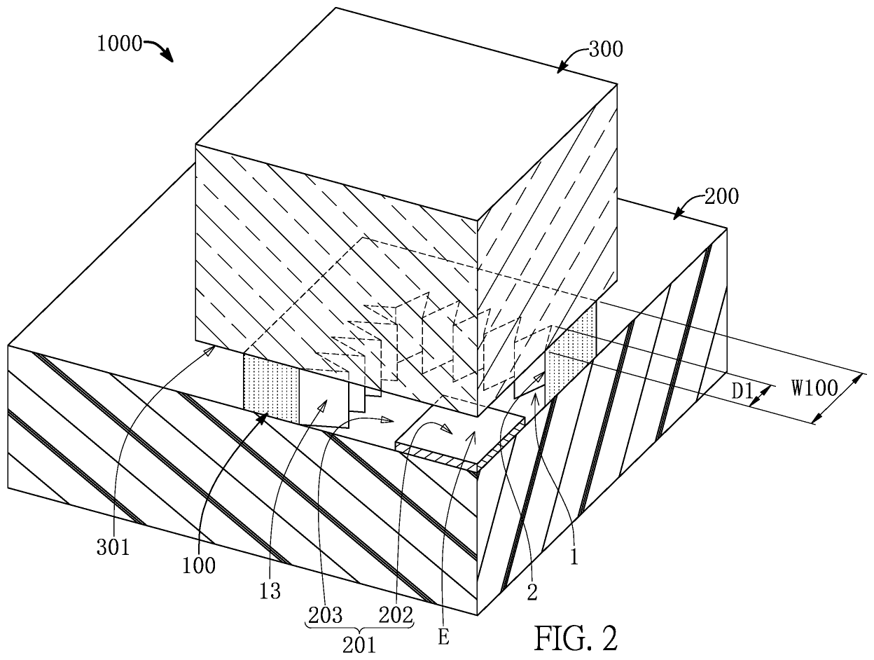

Referring to FIG. 1 to FIG. 9, a first embodiment of the present disclosure is provided. The present embodiment provides an optical device 1000, which includes an electronic component 200, a light-permeable layer 300, and a ring-shaped adhesive layer 100 that is sandwiched between the electronic component 200 and the light-permeable layer 300. Moreover, an inner surface 301 of the light-permeable layer 300, an inner side surface 2 of the ring-shaped adhesive layer 100, and a top surface 201 of the electronic component 200 jointly define an enclosed space E.

Specifically, the top surface 201 of the electronic component 200 has an optical region 202 and a carrying region 203 that surrounds the optical region 202, and the optical region 202 is substantially arranged on a center portion of the top surface 201, but the present disclosure is not limited thereto. Moreover, the ring-shaped adhesive layer 100 is disposed on the carrying region 203 of the electronic component 200 and surrounds the optical region 202. The light-permeable layer 300 in the present embodiment is a flat glass board and is disposed on the ring-shaped layer 100 (through the inner surface 301 thereof).

The ring-shaped adhesive layer 100 includes a plurality of light-weakening slots 1 that are formed on the inner side surface 2 thereof and that face toward the optical region 202. The light-weakening slots 1 are in a ring-shaped arrangement and surround the optical region 202. Each of the light-weakening slots 1 is recessed in the inner side surface 2 and has a slot depth D1 that is less than or equal to 50% of a width W100 of the ring-shaped adhesive layer 100.

Specifically, the light-weakening slots 1 in the present embodiment have a same shape, and slot openings 11 of the light-weakening slots 1 are sequentially connected along a loop path, but the present disclosure is not limited thereto. For example, in other embodiments of the present disclosure not shown in the drawings, the slot openings 11 of any two of the light-weakening slots 1 adjacent to each other can be spaced apart from each other by a distance.

As the light-weakening slots 1 in the present embodiment are of substantially the same shape, the following description discloses the structure of just one of the light-weakening slots 1 for the sake of brevity, but the present disclosure is not limited thereto. For example, in other embodiments of the present disclosure not shown in the drawings, the light-weakening slots 1 can be of different structures.

In the present embodiment, the slot opening 11 of the light-weakening slot 1 has a slot width W1, and a slot bottom 12 of the light-weakening slot 1 is spaced apart from the slot opening 11 by the slot depth D1. Moreover, a width of the light-weakening slot 1 gradually decreases along a direction from the slot opening 11 to the slot bottom 12, and a ratio of the slot width W1 to the slot depth D1 is within a range from 1:0.86 to 1:11.4, such that each of the light-weakening slots 1 is configured to weaken light that irradiates thereon by entering into the enclosed space E.

Accordingly, in the optical device 1000 provided by the present disclosure, by virtue of “the inner side surface 2 of the ring-shaped adhesive layer 100 having the light-weakening slots 1 of the ratio being within a range from 1:0.86 to 1:11.4,” light irradiated on the inner side surface 2 can be weakened by being dispersed into the light-weakening slots 1, thereby effectively preventing the ring-shaped adhesive layer 100 from generating an abnormal refraction or reflection phenomenon due to the light being irradiated thereon.

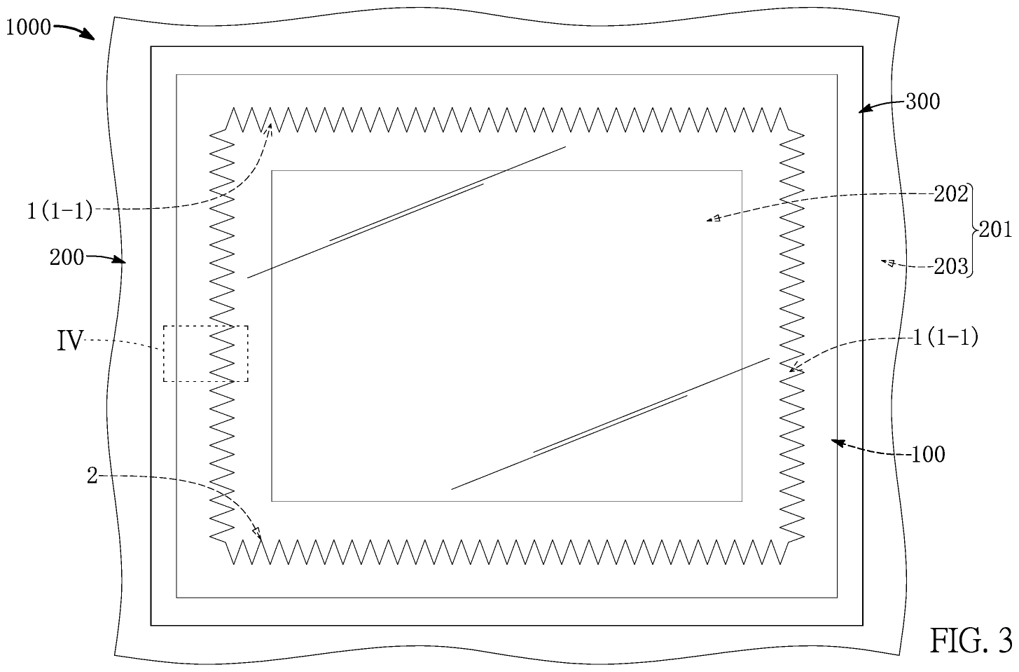

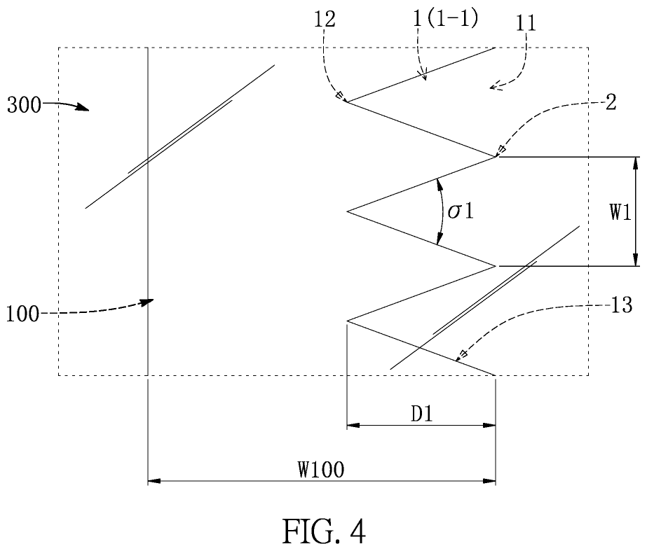

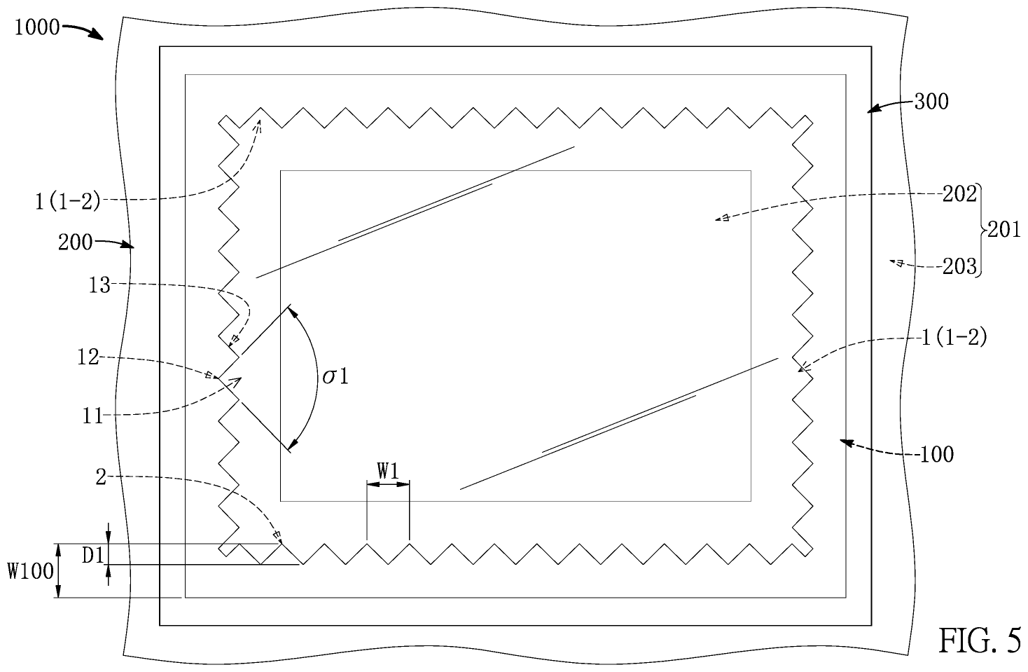

Specifically, the shapes of the light-weakening slots 1 can be provided as shown in FIG. 3 and FIG. 4, and each of the light-weakening slots 1 is defined as a first light-weakening slot 1-1 having the ratio of substantially 1:11.4. Moreover, the shapes of the light-weakening slots 1 can be provided as shown in FIG. 5, and each of the light-weakening slots 1 is defined as a second light-weakening slot 1-2 having the ratio of substantially 1:0.86.

In other words, each of the light-weakening slots 1 has two inner side walls 13 that are sandwiched between the electronic component 200 and the light-permeable layer 300. In each of the light-weakening slots 1, two corresponding ends respectively of the two inner side walls 13 are spaced apart from each other and jointly define the slot opening 11 (and the slot width W1), and the other two corresponding ends respectively of the two inner side walls 13 are connected to each other to jointly define the slot bottom 12.

Specifically, a shape of each of the two inner side walls 13 can be adjusted or changed according to design requirements. For example, as shown in FIG. 4, in each of the light-weakening slots 1, each of the two inner side walls 13 is a flat surface, and the two inner side walls 13 jointly define an angle σ1 therebetween that is within a range from 5 degrees to 60 degrees.

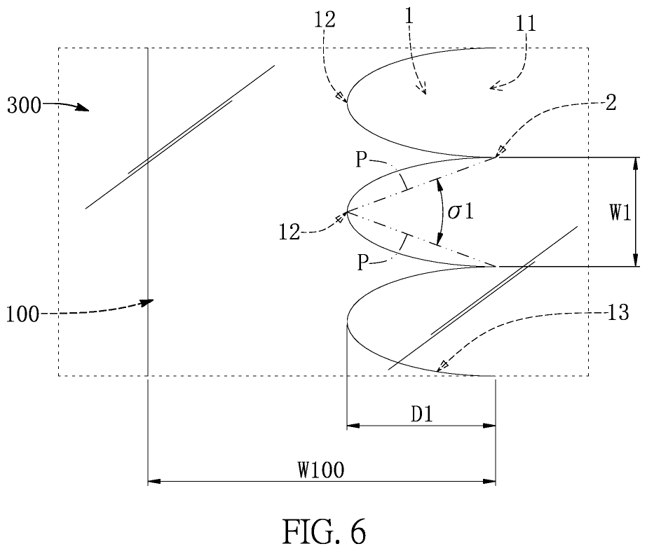

Or, as shown in FIG. 6, in each of the light-weakening slots 1, each of the two inner side walls 13 is a concave surface, and one end of each of the two inner side walls 13 and the slot bottom 12 jointly define an auxiliary plane P passing therethrough. Moreover, in each of the light-weakening slots 1, the two auxiliary planes P are located inside of the two inner side walls 13 and jointly define an angle σ1 therebetween that is within a range from 5 degrees to 60 degrees.

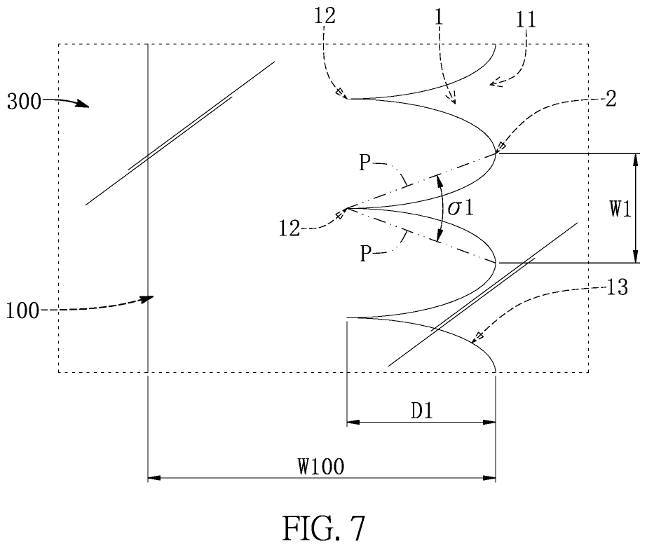

Or, as shown in FIG. 7, in each of the light-weakening slots 1, each of the two inner side walls 13 is a convex surface, and the one end of each of the two inner side walls 13 and the slot bottom 12 jointly define an auxiliary plane P passing therethrough. Moreover, in each of the light-weakening slots 1, the two auxiliary planes P are located outside of the two inner side walls 13 and jointly define an angle σ1 therebetween that is within a range from 5 degrees to 60 degrees.

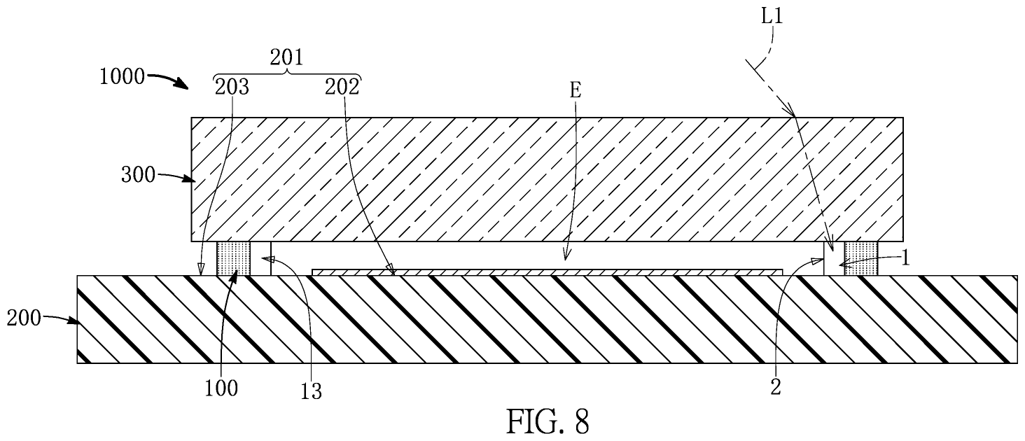

It should be noted that the optical device 1000 can be provided for receiving light L1 or emitting light L2. For example, as shown in FIG. 8, the optical device 1000 can be a sensor package structure, the electronic component 200 is a sensor chip, and each of the light-weakening slots 1 is configured to weaken (or eliminate) the light L1 that irradiates thereon by passing through the light-permeable layer 300, thereby preventing a flare phenomenon from occurring at the optical region 202 of the electronic component 200 (e.g., a sensing region of the sensor chip).

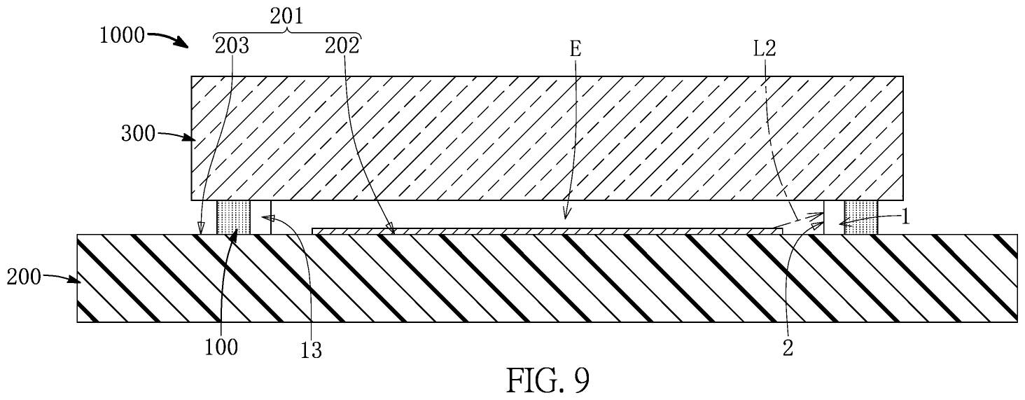

Moreover, as shown in FIG. 9, the optical device 1000 can be a display device, the electronic component 200 is a display module, and each of the light-weakening slots 1 is configured to weaken (or eliminate) the light L2 that is emitted from the optical region 202 of the electronic component 200 (e.g., a light-emitting region of the display module) to irradiate thereon, thereby preventing light spots from occurring at the light-permeable layer 300.

### Second Embodiment

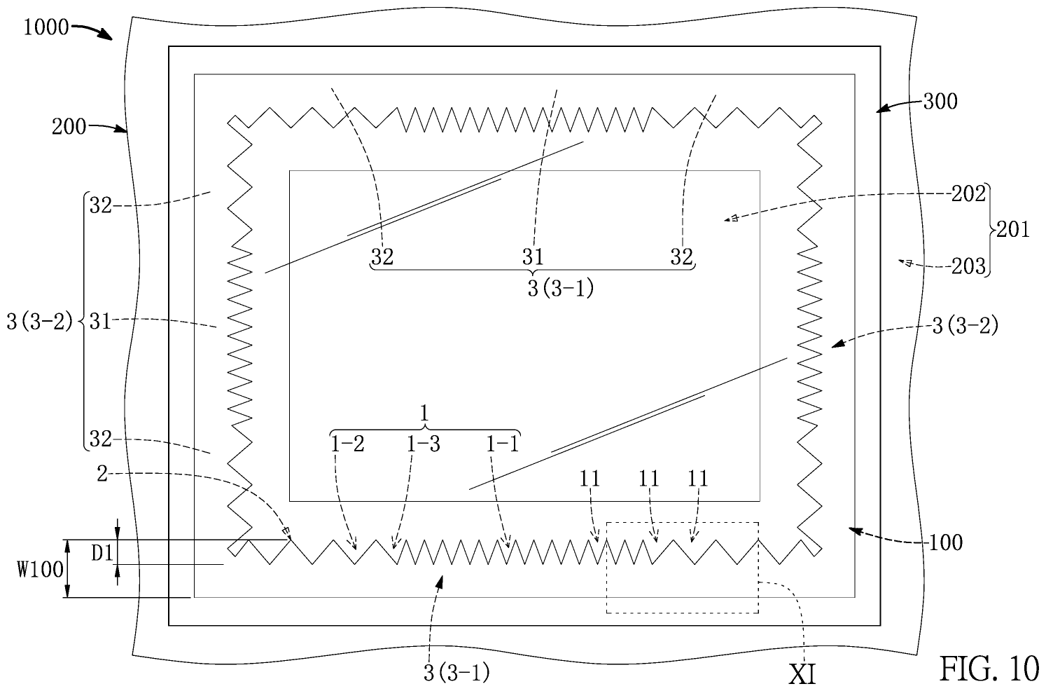

Referring to FIG. 10 to FIG. 12, a second embodiment of the present disclosure, which is similar to the first embodiment of the present disclosure, is provided. For the sake of brevity, descriptions of the same components in the first and second embodiments of the present disclosure (e.g., the electronic component 200, the light-permeable layer 300, and the shape or structure of the light-weakening slot 1) will be omitted herein, and the following description only discloses different features between the first and second embodiments (e.g., the structure of the ring-shaped adhesive layer 100).

Specifically, since light is irradiated on different portions of the ring-shaped adhesive layer 100 by different strengths and angles, the ring-shaped adhesive layer 100 in the present embodiment further defines the shape and distribution of the light-weakening slots 1 for allowing the optical device 1000 to be applied under different requirements.

In the present embodiment, the ring-shaped adhesive layer 100 includes a plurality of strips 3 in a (rectangular) ring-shaped arrangement, and each of the strips 3 includes an inner layout segment 31 and two outer layout segments 32 that are respectively connected to two opposite ends of the inner layout segment 31. In each of the strips 3 of the present embodiment, a length of the inner layout segment 31 is within a range from 90% to 120% of a sum of lengths of the two outer layout segments 32, but the present disclosure is not limited thereto.

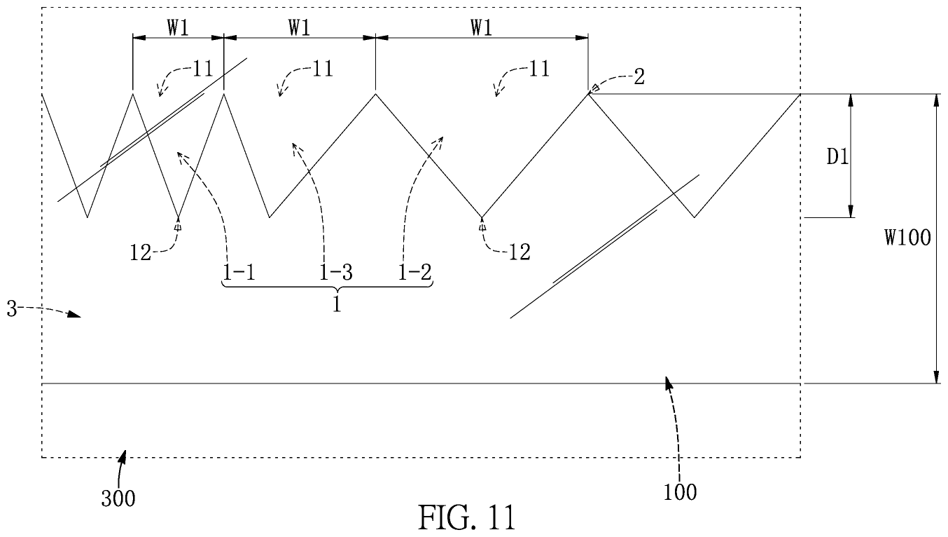

As shown in FIG. 10 and FIG. 11, the light-weakening slots 1 of the present embodiment include a plurality of first light-weakening slots 1-1, a plurality of second light-weakening slots 1-2, and a plurality of third light-weakening slots 1-3. Each of the first light-weakening slots 1-1 has a first shape that is different from a second shape of each of the second light-weakening slots 1-2, and each of the third light-weakening slots 1-3 has a third shape formed by a half of the first shape and a half of the second shape, but the present disclosure is not limited thereto. For example, in other embodiments of the present disclosure not shown in the drawings, the light-weakening slots 1 can be provided without the third light-weakening slots 1-3.

It should be noted that the ratio of the first light-weakening slot 1-1 is substantially 1:11.4, the ratio of the second light-weakening slot 1-2 is substantially 1:0.86, and the ratio of the third light-weakening slot 1-3 is within a range from 1:0.86 to 1:11.4, but the present disclosure is not limited thereto. In other words, according to design requirements, the ratio of any one of the light-weakening slots 1 can be changed or adjusted in the range from 1:0.86 to 1:11.4.

Specifically, the first light-weakening slots 1-1 are recessed in the inner layout segments 31 of the strips 3 (i.e., the first light-weakening slots 1-1 are recessed in the inner layout segments 31 of any two of the strips 3 facing toward each other), the second light-weakening slots 1-2 are recessed in the outer layout segments 32 of the strips 3, and the third light-weakening slots 1-3 are recessed in connection parts between the inner layout segment 31 and the two outer layout segments 32 of each of the strips 3.

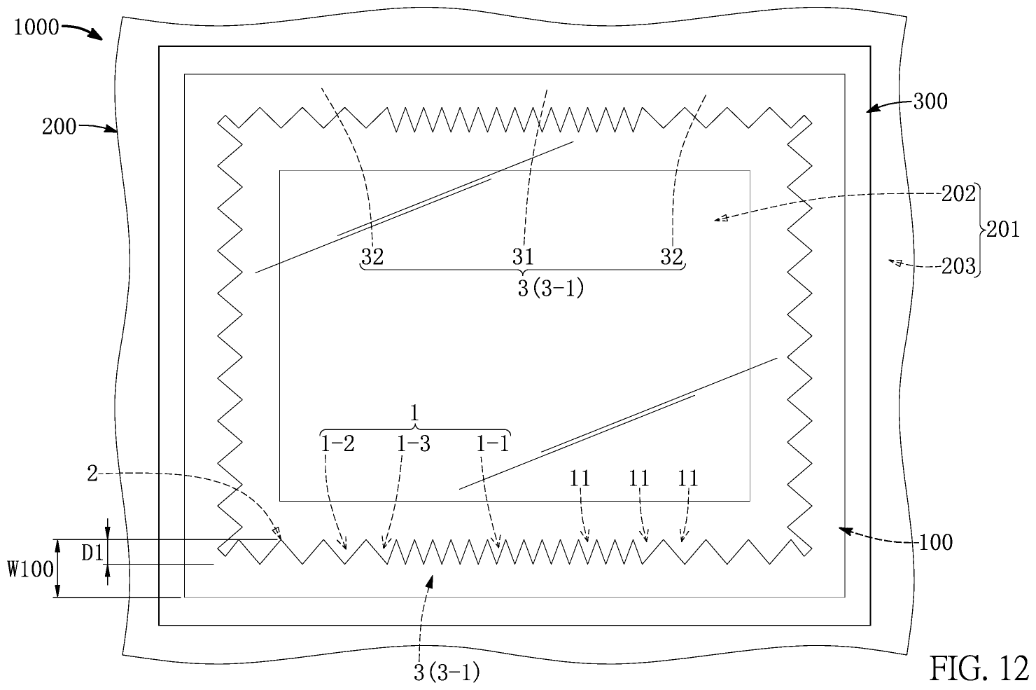

Moreover, as shown in FIG. 12, the strips 3 are in a rectangular ring-shaped arrangement and include two first strips 3-1 facing each other and two second strips 3-2 facing each other. Moreover, a length of each of the two first strips 3-1 in the present embodiment is greater than a length of each of the two second strips 3-2, but the present disclosure is not limited thereto. For example, in other embodiments of the present disclosure not shown in the drawings, the length of each of the two first strips 3-1 can be less than or equal to the length of each of the two second strips 3-2.

As shown in FIG. 12 of the present embodiment, the first light-weakening slots 1-1 are recessed in the inner layout segments 31 of the two first strips 3-1, the second light-weakening slots 1-2 are recessed in the second strips 3-2 and the outer layout segments 32 of the two first strips 3-1, and the third light-weakening slots 1-3 are recessed in connection parts between the inner layout segment 31 and the two outer layout segments 32 of each of the two first strips 3-1. Furthermore, a quantity of the first light-weakening slots 1-1 is within a range from 90% to 110% of a quantity of the second light-weakening slots 1-2.

In summary, as shown in FIG. 10 to FIG. 12, the light-weakening slots 1 in the present embodiment are in a ring-shaped arrangement and surround the optical region 202, the slot depth D1 of each of the light-weakening slots 1 is less than or equal to 50% of a width W100 of the corresponding strip 3, and the slot openings 11 of the light-weakening slots 1 formed on each of the strips 3 are coplanar with each other.

Accordingly, the optical device 1000 provided by the present embodiment have the light-weakening slots 1 of different shapes (e.g., the first light-weakening slots 1-1, the second light-weakening slots 1-2, and the third light-weakening slots 1-3), so that distribution of the light-weakening slots 1 can be adjusted to weaken light irradiated on different portions of the ring-shaped adhesive layer 100 for effectively preventing the ring-shaped adhesive layer 100 from generating the abnormal refraction or reflection phenomenon due to the light being irradiated thereon, thereby allowing the optical device 1000 to be applied under different requirements.

### Third Embodiment

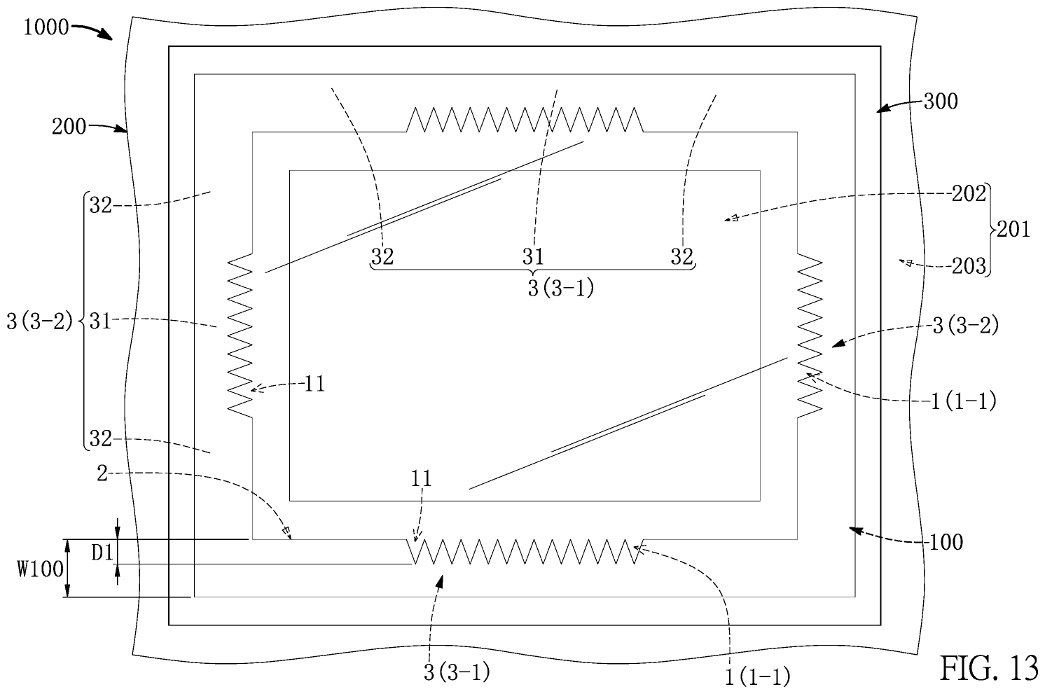

Referring to FIG. 13 to FIG. 15, a third embodiment of the present disclosure, which is similar to the second embodiment of the present disclosure, is provided. For the sake of brevity, descriptions of the same components in the second and third embodiments of the present disclosure will be omitted herein, and the following description only discloses different features between the second and third embodiments (e.g., the structure of the ring-shaped adhesive layer 100).

Specifically, since an abnormal optical phenomenon can easily occur at a specific portion of the ring-shaped adhesive layer 100 (e.g., a center portion of each of the strips 3 easily has a fare phenomenon or light spots), the ring-shaped adhesive layer 100 in the present embodiment further defines the shape and distribution of the light-weakening slots 1 for effectively improving the ring-shaped adhesive layer 100 generating the abnormal optical phenomenon.

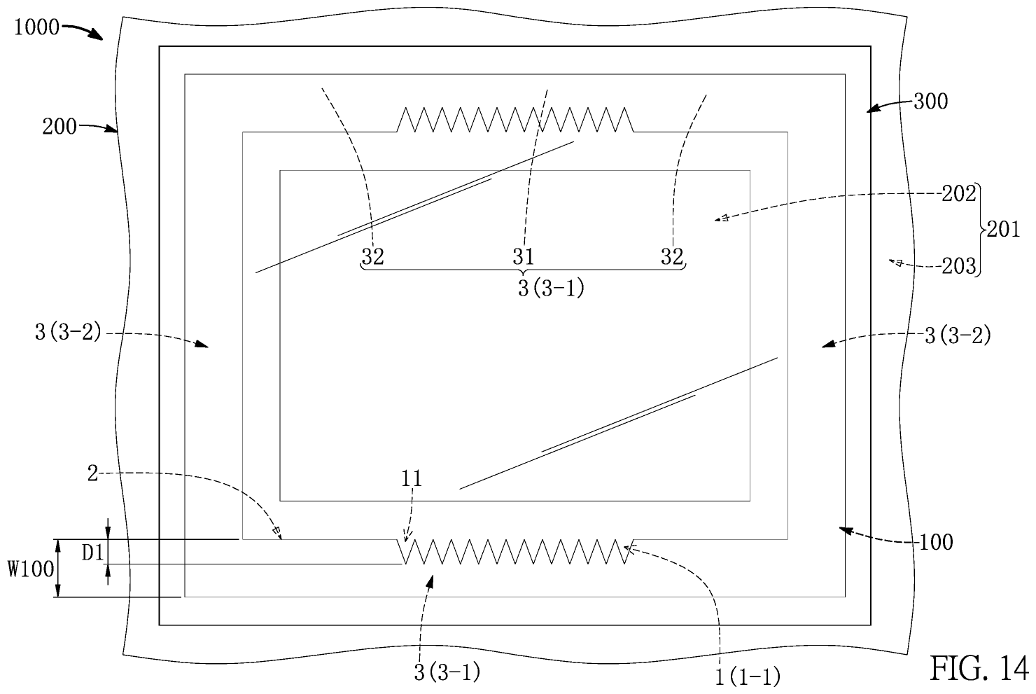

As shown in FIG. 13 of the present embodiment, the light-weakening slots 1 are recessed in the inner layout segments 31 of the strips 3 (i.e., the light-weakening slots 1 are recessed in the inner layout segments 31 of any two of the strips 3 facing toward each other), and the two outer layout segments 32 of each of the strips 3 do not have any slots and are flat shapes that are coplanar with the slot openings 11 of the light-weakening slots 1. Or, as shown in FIG. 14, the light-weakening slots 1 are only formed on the inner layout segments 31 of the two first strips 3-1, and the second strips 3-2 and the outer layout segments 32 of the two first strips 3-1 do not have any slots and are flat shapes.

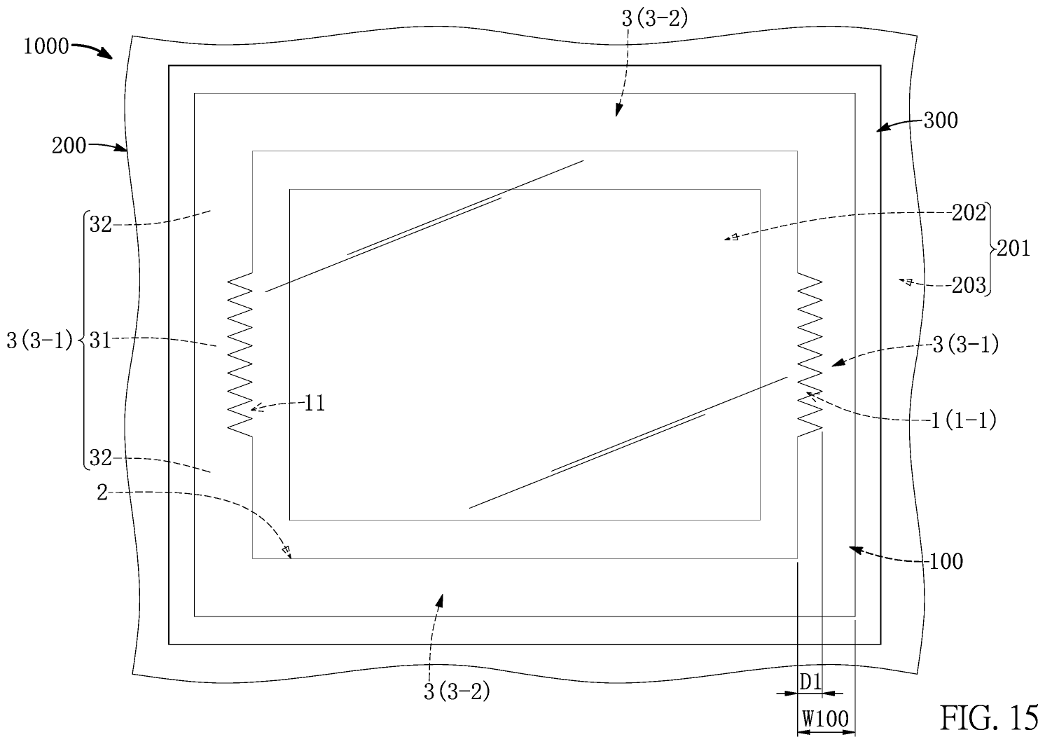

As shown in FIG. 14 of the present embodiment, the slot openings 11 of the light-weakening slots 1 formed on each of the first strips 3-1 are coplanar with each other, and a length of each of the first strips 3-1 is greater than a length of any one of the second strips 3-2, but the present disclosure is not limited thereto. For example, as shown in FIG. 15, a length of each of the first strips 3-1 can be less than a length of any one of the second strips 3-2. In addition, in other embodiments of the present disclosure not shown in the drawings, length of each of the first strips 3-1 can be equal to a length of any one of the second strips 3-2.

It should be noted that since a part of the inner side surface 2 of the ring-shaped adhesive layer 100 is a flat shape, the ratio of the each of the light-weakening slots 1 (e.g., the first light-weakening slots 1-1) is preferably 1:11.4 for effectively preventing the ring-shaped adhesive layer from generating the abnormal refraction or reflection phenomenon due to the light being irradiated thereon, but the present disclosure is not limited thereto.

### Beneficial Effects of the Embodiments

In conclusion, in the optical device provided by the present disclosure, by virtue of “the inner side surface of the ring-shaped adhesive layer having the light-weakening slots of the ratio being within a range from 1:0.86 to 1:11.4,” light irradiated on the inner side surface can be weakened by being dispersed into the light-weakening slots, thereby effectively preventing the ring-shaped adhesive layer from generating an abnormal refraction or reflection phenomenon due to the light being irradiated thereon.

Moreover, the optical device provided by the present disclosure has the light-weakening slots of different shapes, so that distribution of the light-weakening slots can be adjusted to weaken light irradiated on different portions of the ring-shaped adhesive layer for further effectively preventing the ring-shaped adhesive layer from generating the abnormal refraction or reflection phenomenon due to the light being irradiated thereon, thereby allowing the optical device to be applied to different requirements.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical device, comprising:
an electronic component having a top surface, wherein the top surface of the electronic component has an optical region and a carrying region that surrounds the optical region;
a ring-shaped adhesive layer disposed on the carrying region of the electronic component and surrounding the optical region, wherein the ring-shaped adhesive layer includes a plurality of light-weakening slots that are formed on an inner side surface thereof and that face toward the optical region, wherein the ring-shaped adhesive layer includes a plurality of strips in a ring-shaped arrangement, and each of the strips includes an inner layout segment and two outer layout segments that are respectively connected to two opposite ends of the inner layout segment, and wherein the light-weakening slots are recessed in the inner layout segments of two of the strips facing toward each other; and
a light-permeable layer disposed on the ring-shaped adhesive layer, wherein the light-permeable layer, the inner side surface of the ring-shaped adhesive layer, and the top surface of the electronic component jointly define an enclosed space;
wherein each of the light-weakening slots has a slot opening and a slot bottom that is spaced apart from the slot opening by a slot depth, and wherein a width of each of the light-weakening slots gradually decreases along a direction from the slot opening to the slot bottom, the slot opening each of the light-weakening slots has a slot width, and a ratio of the slot width to the slot depth is within a range from 1:0.86 to 1:11.4, such that each of the light-weakening slots is configured to weaken light that irradiates thereon by entering into the enclosed space.

2. The optical device according to claim 1, wherein each of the light-weakening slots includes two inner side walls, and wherein, in each of the light-weakening slots, two corresponding ends respectively of the two inner side walls are spaced apart from each other and jointly define the slot opening, and another two corresponding ends of the two inner side walls are connected to each other to jointly define the slot bottom.

3. The optical device according to claim 2, wherein, in each of the light-weakening slots, each of the two inner side walls is a flat surface, and the two inner side walls jointly define an angle therebetween that is within a range from 5 degrees to 60 degrees.

4. The optical device according to claim 2, wherein, in each of the light-weakening slots, each of the two inner side walls is a concave surface, and the one end of each of the two inner side walls and the slot bottom jointly define an auxiliary plane passing therethrough, and wherein, in each of the light-weakening slots, the two auxiliary planes are located inside of the two inner side walls and jointly define an angle therebetween that is within a range from 5 degrees to 60 degrees.

5. The optical device according to claim 2, wherein, in each of the light-weakening slots, each of the two inner side walls is a convex surface, and the one end of each of the two inner side walls and the slot bottom jointly define an auxiliary plane passing therethrough, and wherein, in each of the light-weakening slots, the two auxiliary planes are located outside of the two inner side walls and jointly define an angle therebetween that is within a range from 5 degrees to 60 degrees.

6. The optical device according to claim 2, wherein the two inner side walls of each of the light-weakening slots are sandwiched between the electronic component and the light-permeable layer.

7. The optical device according to claim 1, wherein the light-weakening slots are recessed in the inner layout segments of the strips, and no slots are formed on the two outer layout segments of each of the strips.

8. The optical device according to claim 1, wherein the light-weakening slots include a plurality of first light-weakening slots and a plurality of second light-weakening slots, each of the first light-weakening slots has a first shape and each of the second light-weakening slots has a second shape, and the first shape is different from the second shape, and wherein the first light-weakening slots are recessed in the inner layout segments of the strips, and the second light-weakening slots are recessed in the outer layout segments of the strips.

9. The optical device according to claim 8, wherein the light-weakening slots further include a plurality of third light-weakening slots recessed in connection parts between the inner layout segment and the two outer layout segments of each of the strips, and each of the third light-weakening slots has a third shape formed by a half of the first shape and a half of the second shape.

10. The optical device according to claim 8, wherein the light-weakening slots are in a ring-shaped arrangement and surround the optical region.

11. The optical device according to claim 1, wherein the strips are in a rectangular ring-shaped arrangement and include two first strips facing each other and two second strips facing each other, and wherein the light-weakening slots are only formed on the inner layout segments of the two first strips, and no slots are formed on the second strips and the outer layout segments of the two first strips.

12. The optical device according to claim 1, wherein the strips are in a rectangular ring-shaped arrangement, and include two first strips facing each other and two second strips facing each other, the light-weakening slots include a plurality of first light-weakening slots and a plurality of second light-weakening slots, each of the first light-weakening slots has a first shape, and each of the second light-weakening slots has a second shape that is different from the first shape, and wherein the first light-weakening slots are recessed in the inner layout segments of the two first strips, and the second light-weakening slots are recessed in the second strips and the outer layout segments of the two first strips.

13. The optical device according to claim 12, wherein the light-weakening slots further include a plurality of third light-weakening slots recessed in connection parts between the inner layout segment and the two outer layout segments of each of the two first strips, and each of the third light-weakening slots has a third shape formed by a half of the first shape and a half of the second shape.

14. The optical device according to claim 12, wherein a quantity of the first light-weakening slots is within a range from 90% to 110% of a quantity of the second light-weakening slots.

15. The optical device according to claim 1, wherein the slot openings of the light-weakening slots are coplanar with each other.

16. The optical device according to claim 1, wherein the slot depth of each of the light-weakening slots is less than or equal to 50% of a width of a corresponding one of the strips.

17. The optical device according to claim 1, wherein, in each of the light-weakening slots, a length of the inner layout segment is within a range from 90% to 120% of a sum of lengths of the two outer layout segments.

18. An optical device, comprising:
an electronic component having a top surface, wherein the top surface of the electronic component has an optical region and a carrying region that surrounds the optical region;
a ring-shaped adhesive layer disposed on the carrying region of the electronic component and surrounding the optical region, wherein the ring-shaped adhesive layer includes a plurality of light-weakening slots that are formed on an inner side surface thereof and that face toward the optical region, and wherein the light-weakening slots are in a ring-shaped arrangement and surround the optical region; and
a light-permeable layer disposed on the ring-shaped adhesive layer, wherein the light-permeable layer, the inner side surface of the ring-shaped adhesive layer, and the top surface of the electronic component jointly define an enclosed space;
wherein each of the light-weakening slots has a slot opening and a slot bottom that is spaced apart from the slot opening by a slot depth, and wherein a width of each of the light-weakening slots gradually decreases along a direction from the slot opening to the slot bottom, the slot opening each of the light-weakening slots has a slot width, and a ratio of the slot width to the slot depth is within a range from 1:0.86 to 1:11.4, such that each of the light-weakening slots is configured to weaken light that irradiates thereon by entering into the enclosed space.

19. The optical device according to claim 18, wherein the light-weakening slots have a same shape.

20. The optical device according to claim 19, wherein the slot depth of each of the light-weakening slots is less than or equal to 50% of a width of the ring-shaped adhesive layer.
